(19) United States
(12) Patent Application Publication
(10) Pub. No.: US 2022/0219637 A1
(43) Pub. Date: Jul. 14, 2022

(54) ROLL CAGE

(71) Applicant: Dominik Koller, Burglengenfeld (DE)

(72) Inventor: Dominik Koller, Burglengenfeld (DE)

(21) Appl. No.: 17/643,773

(22) Filed: Dec. 10, 2021

(30) Foreign Application Priority Data
Jan. 8, 2021 (DE) 102021100189.7

(51) Int. Cl. B60R 21/13

(52) U.S. Cl. CPC B60R 21/13; B60R 2021/137

(57) ABSTRACT

The invention relates to a roll cage for a motor vehicle that has Isofix attachment points in the rear section of the motor vehicle interior, wherein the roll cage is formed by a rollbar that has at least four mounting points for securing and supporting the rollbar in the motor vehicle, two of which mounting points form two first mounting points in the form of clamp elements that clamp onto at least two Isofix attachment points, and the other two of which form two support elements, which support the rollbar in the passenger compartment, in particular on its floor. Such a roll cage can be installed quickly, and does not require approval.

### CROSS-REFERENCE TO RELATED APPLICATIONS

This application claims the benefit of German Patent Application No. DE 10 2021 100 189.7, filed Jan. 8, 2021, the disclosure of which is hereby incorporated herein in its entirety by reference.

### FIELD OF THE INVENTION

The invention relates to a roll cage for a motor vehicle with Isofix attachment points in the rear of an automobile interior. The Isofix attachment points in a motor vehicle are used in particular for attaching a child seat. They comply with the ISO 13216 standard and are composed of two mounts that are 6 mm thick, located at a spacing of 280 mm in the gap between the backrests and seat cushions of each seat in the rear part of the vehicle interior. They are now standard attachment points in passenger automobiles.

### BACKGROUND OF THE INVENTION

A roll cage is normally formed by a rollbar with at least four mounting points for securing the rollbar to the motor vehicle. In the case of an accident, in particular in which the vehicle rolls over, the passenger compartment is reinforced such that it does not become deformed in a manner dangerous for the driver and passengers. In particular, racecars and sportscars are currently equipped with such roll cages for safety reasons.

Rollbars are normally attached to the vehicle chassis and/or the vehicle framework. Because this involves an engagement in the structure of the vehicle, in some jurisdictions these rollbars must be registered in the licensing office.

### SUMMARY OF THE INVENTION

The object of the present invention is to create a roll cage that can be installed in a vehicle after production, and preferably does not have to be registered.

This object is achieved according to the invention by a roll cage according to the claims. Further advantageous aspects, details, and designs of the invention can be derived from the description, and the drawings.

The roll cage according to the invention is formed by a rollbar that is attached to and/or supported in the vehicle with at least four mounting points. The roll cage is designed for vehicles that have Isofix attachment points in the rear of the automobile's interior. Of the four mounting points, two are designed as clamp elements that engage with at least two of the Isofix attachment points. Two of the other mounting points are designed as support elements that brace the rollbar against the passenger compartment, in particular the floor thereof.

The invention has the advantage that the roll cage can be quickly and easily installed in the vehicle, and is not permanently attached to the vehicle's chassis. The use of the roll cage therefore does not require approval and/or registry in the vehicle title according to the current approval provisions of some jurisdictions.

The roll cage is nevertheless able to absorb forces acting on the passenger compartment in the case of an accident, thus preventing a life-threatening deformation of the passenger compartment.

As explained above, the Isofix attachment points in the vehicle are composed of two mounts that are 6 mm thick on each seat, which are spaced 280 mm apart in the gap between the backrest and the seat in the rear of the vehicle. If the normal Isofix attachment points are provided on the two outer rear seats in the vehicle then there are four mounts in the rear of the vehicle interior, wherein the spacing between the mounts for the two outer rear seats may vary, and depends on the size of the vehicle.

The spacing between the two first mounting points can therefore be adjusted precisely to a specific type of vehicle, e.g. a VW Golf IV. A greater range of use and variability is obtained for different types of vehicles if the spacing between the first mounting points can be adjusted. This adjustability can be obtained, for example, in the adjustable receivers on the rollbar for the first mounting points. In this manner, production tolerances can also be accounted for in a vehicle with regard to the spacing between the outermost Isofix attachment points.

In principle, the roll cage can have just two first mounting points, in particular for the outermost mounts on the Isofix attachment points in the vehicle. If the rollbar is to be securely attached to the vehicle in a particularly robust manner, there can also be four first mounting points on the rollbar, which are then attached to all four Isofix attachment points in the vehicle for the two outer rear seats.

It should be noted that the roll cage also has an aesthetic value, and the roll cage according to the invention does not provide the same level of vehicle safety that is obtained with a roll cage that is permanently attached to the chassis of the vehicle.

In general, it is possible that the rollbar simply has feet plates at the bottom that are basically the same size or slightly larger than the tubes forming the rollbar, such that the end of the tube is simply closed with a plate, for example. This may be necessary for some vehicles due to the available space therein.

The supporting elements preferably have support plates, however, which are designed to fit in the vehicle at the side of the passenger compartment and/or on the floor thereof.

These support plates should be of a minimum size for this, in order to absorb the forces acting on the chassis in the rollbar in the case of an accident, and thus prevent perforation of the floor where the plates press against it. An appropriate minimum size would be 100 mm×100 mm, preferably 200 mm×200 mm, and ideally 200-250 mm×250-350 mm in the case of a rectangular surface of the support plate, for example, depending on which size fits best on the floor in the rear of the passenger compartment.

According to a preferred embodiment, the support plates weigh between 5 and 15 kg, in particular 8 to 10 kg. As a result, the rollbar remains in place on the floor of the vehicle due to the weight of the support plates.

In an advantageous development of the invention, the support plates have flanges that can be attached to the lower ends of the tubes forming the rollbar. The support plates can thus be attached to the rollbar after the rollbar has been positioned in the vehicle. This significantly simplifies the installment of the roll cage in the vehicle. The attachment can preferably be obtained using screw clamps, which connect the lower ends of the tubes of the rollbar to the flanges.

The clamp elements are preferably made of two oblong clamp parts, in particular metal brackets that can be connected to one another by at least one threaded bolt, where at least one of the clamp parts has at least one recess on its side facing the other clamp part for a mount on the Isofix attachment point.

A first clamp part is preferably welded to the rollbar, and the second clamp part is preferably screwed to the first clamp part. This design can be produced easily, and simplifies installation.

Because the mount is formed by a web that has a diameter of 6 mm, the receiver of clamp element is preferably formed by the semicylindrical channels in both clamp parts facing one another. Alternatively, the recess can be formed entirely in one of the clamp parts, in which case the recess formed in the one clamp part is simply covered by the other clamp part.

In a very stable and easily produced embodiment of the invention, the two clamp parts are made of metal strips or brackets that are 4 to 10 mm thick, in particular 5 to 8 mm thick. This has the advantage that forces can be effectively transferred due to the thickness of the materials. The materials are also thick enough that a 3 mm channel can be formed therein for the 6 mm thick mount, without deforming it, such that the two half-channels in the two clamp parts face one another, thus forming a cylindrical hole for the mount with a 6 mm diameter.

The two clamp parts therefore preferably have a cylindrical channel or groove on their sides facing one another, with a diameter of at least 5 mm, in particular 5.5 mm to 6.5 mm. The trough is transverse to the longitudinal axis of the clamp part in each case. The troughs face each other on the two clamp parts that are screwed together, thus forming the receiver for the mount.

The mount on the Isofix attachment point is preferably clamped between the two clamp parts, such that any play is eliminated. The diameter of the recess in at least one of the clamp parts can therefore be slightly smaller than the diameter of the mount, e.g. 5.9 mm.

To attach the two clamp parts securely but releasably, they can be connected to one another by at least one, preferably at least two threaded bolts, placed successively in the longitudinal direction. The two clamp parts are first screwed together when the rollbar is placed correctly in the vehicle, and the mount lies in the trough or recess of at least one clamp part. The installation is thus simplified in this embodiment.

If the distance between the holes for the bolts is at least 3 cm, preferably at least 5 cm, the tightening area is not affected by the seat cushions in the rear, and the installation is easier.

In order to be able to withstand the potentially strong forces that may act on the roll cage in the case of an accident, the rollbar and/or the mounting points are made of metal, in particular steel. Preferably, both the rollbar and the mounting points are made of steel. As a result, the forces acting on the passenger compartment can be effectively transferred by the roll cage to the Isofix attachment points and the vehicle chassis.

The following expressions are used synonymously: first mounting point—clamp element; clamp part—metal strip, metal bracket; second mounting point—support element.

It is clear to the person skilled in the art that the embodiments described above can be combined arbitrarily with one another, as long as the embodiments are not mutually exclusive.

Developments, advantages and application possibilities of the invention can be derived from the following description of exemplary embodiments and from the drawings. All of the features described and/or illustrated in the drawings are fundamentally part of the invention in and of themselves or in arbitrary combinations thereof, independently of their descriptions in the claims or the references made thereto.

### BRIEF DESCRIPTION OF THE DRAWINGS

The invention shall be described in greater detail below on the basis of exemplary embodiments in conjunction with the schematic drawings. Wherein:

FIG. 1 shows a side view of a roll cage according to an embodiment of the invention in a motor vehicle;

FIG. 2 shows a rear view of the roll cage shown in FIG. 1;

FIG. 3 shows a detailed view of the support element in a fragmentary, side view;

FIG. 4 shows a top view of the support element;

FIG. 5 shows a top view of a clamp element; and

FIG. 6 shows a longitudinal cut through the clamp element shown in FIG. 5.

### DETAILED DESCRIPTION OF AN EMBODIMENT OF THE INVENTION

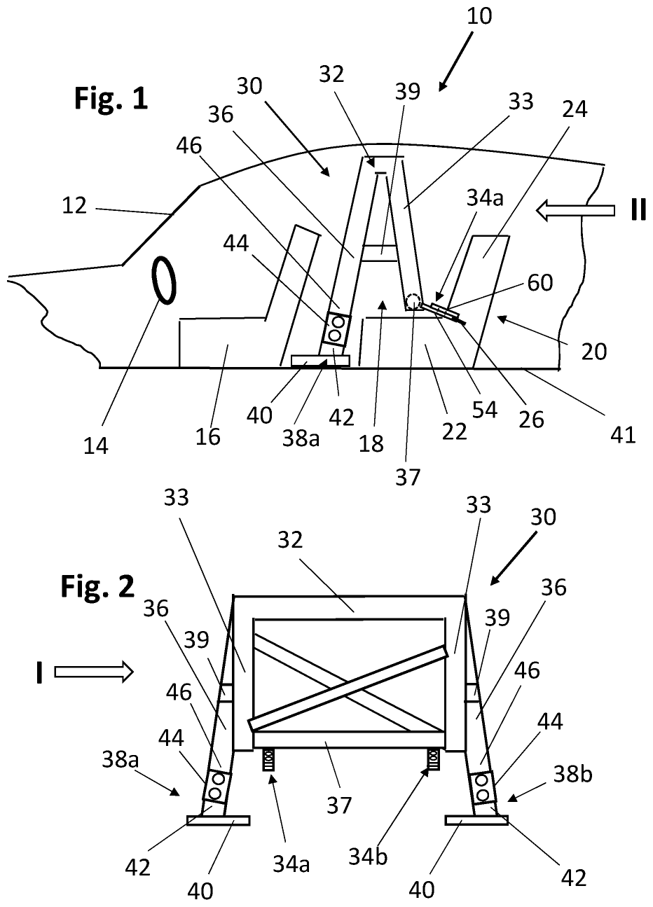

FIG. 1 shows a schematic and very simplified illustration of a passenger compartment 10 in a motor vehicle, with a windshield 12, steering wheel 14, front seats 16, rear section 18 behind the front seats, and a back seat 20.

A mount 26 for an Isofix attachment point is located in the known manner on the back seat 20 in the gap between the seat 22 and the backrest 24. These attachment points are usually used for securing child seats.

A roll cage 30 is located in the rear section 18 of the passenger compartment 10, which shall be explained in greater detail in reference to FIGS. 1 and 2.

The roll cage 30 contains a rollbar 32, which, seen from the side, has an A-frame structure with a front leg 36 and rear leg 33, connected by a horizontal connecting web 39. The rear leg 33 has a horizontal web 37 at its lower end, which has two first mounting points 34a, 34b, each of which can be secured to a mount 26 on an Isofix attachment point, preferably on both sides at the outermost Isofix attachment points.

The front leg 36 extends into the footwell in front of the back seat 20, and is supported by two supporting elements 38a, 38b on the floor 41 of the passenger compartment 10. Each supporting element 38a, 38b is composed of a support plate 40 with a flange 42, which is connected to the lower end 46 of the front leg 36 of the rollbar 32 by a screw clamp 44.

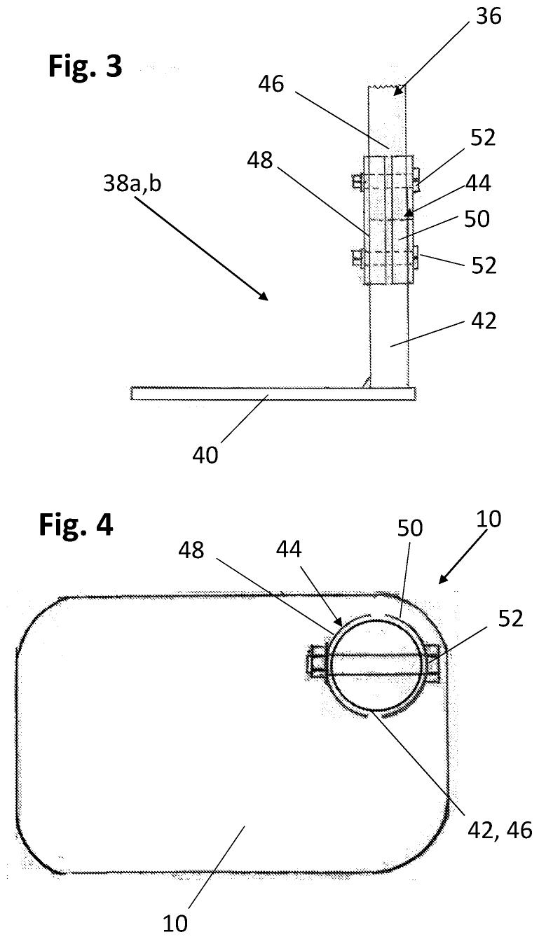

The support elements 38a, 38b are shown in greater detail in FIGS. 3 and 4. They are composed of the support plate 40, which is preferably 150 milimeters (mm)×250 mm to 200 mm×350 mm, and therefore supported with a large surface area on the floor 41 of the passenger compartment. The weight is preferably numerous kilograms, preferably 5 to 15 kg, such that the weight of the support plates 40 keeps the rollbar 32 securely on the floor 41 of the passenger compartment 10.

The flange 42, i.e. a tube flange, is welded to the support plate 40. The flange 42 preferably has the same diameter as the lower end 46 of the front leg 36 of the rollbar 32. It is then connected via the screw clamp, or tube screw clamp 44. The tube screw clamp 44 is composed of two half-clamps 48, 50, which are tightened to one another by two screws 52 that pass through the flange 42 and the lower end 46 of the front leg 36, thus securely connecting the lower end 46 and the flange 42 to one another.

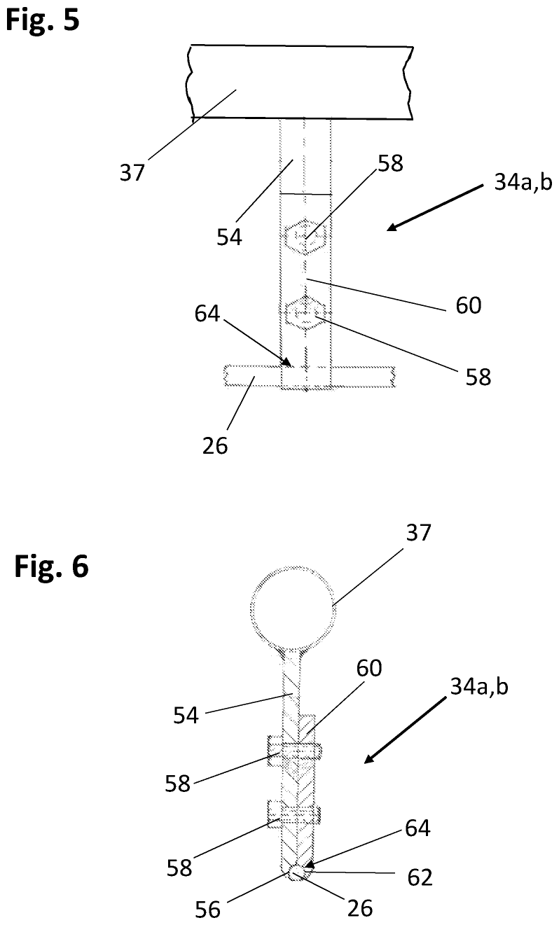

The clamp elements 34a, 34b are shown in greater detail in FIGS. 5 and 6. The clamp elements 34a, 34b are composed of a first clamp part 54, which is welded to the horizontal web 37 of the rollbar (FIG. 2). The first clamp part 54 forms an oblong metal bracket with a material thickness of preferably at least 5 mm.

The first clamp part 54 has a cylindrical trough 56, transverse to the longitudinal axis, at its front end, which encompasses the mount 26 on the Isofix attachment point over approximately 180°. A second clamp part 60 is secured by two screws 58 to the first clamp part 54, which also forms an oblong metal bracket with a thickness of preferably at least 5 mm. The second clamp part 60 also has a complementary trough 62 at its front end, lying opposite the trough 56 on the first clamp part 54, such that the two troughs form a cylindrical hole 64 that entirely encompasses the mount 26, thus securing the rollbar 32 to the mount 26 on the corresponding Isofix attachment point.

There can be two or four first mounting points in the form of these clamp elements 34, which are secured to a corresponding number of mounts 26 in the rear section 18 of the vehicle's interior.

The rollbar 32 is securely anchored to the Isofix attachment points in this manner, and it is also supported on the floor 41 of the passenger compartment. The roll cage 30 can thus be quickly installed, without having to be registered, and it is also robust and functional.

It is clear to the person skilled in the art that the invention is not limited by the description of the drawings, and can be varied within the scope of protection of the subordinate claims.

### LIST OF REFERENCE SYMBOLS

10 passenger compartment in the vehicle
12 windshield on the vehicle
14 steering wheel
16 front seat
18 rear section of the passenger compartment
20 back seat
22 seat part of the back seat
24 backrest on the back seat
26 mount on the Isofix attachment point
30 roll cage
32 rollbar
33 rear leg of the A-frame rollbar
34a, b first mounting point—clamp element
36 front leg of the A-frame rollbar
37 lower horizontal web of the rear leg for attaching the first mounting point
38a,b second mounting point—support element
39 connecting web between the front and rear leg
40 support plate of the support element
42 flange welded to the support plate of the support element
44 screw clamp—tube screw clamp for attaching the support element to the lower end of the front leg
46 lower end of the front leg of the rollbar
48 first half-clamp of the screw clamp
50 second half-clamp of the screw clamp
52 screws for tightening the two half-clamps
54 first clamp part—metal bracket
56 cylindrical trough in first clamp part, transverse to the longitudinal direction for clamping the mount
58 screws for tightening the clamp parts to one another
60 second clamp part—metal bracket
62 cylindrical trough in first clamp part, transverse to the longitudinal direction, for clamping the mount
64 cylindrical hole for receiving the mount, formed by the troughs in the two clamp parts facing one another

What is claimed is:

1. A roll cage for a passenger compartment of a motor vehicle, which has at least two Isofix attachment points in a rear section of the passenger compartment of the motor vehicle, wherein the roll cage is formed by a rollbar that has at least two clamp elements that clamp onto the at least two Isofix attachment points, and two support elements, which support the rollbar on a floor of the passenger compartment.

2. The roll cage according to claim 1, wherein each of the two support elements comprises a support plate.

3. The roll cage according to claim 2, wherein each of the support plates includes a flange attached to a lower end of a tube forming a downwardly extending leg of the rollbar.

4. The roll cage according to claim 3, wherein the flange of each of the support plates and the lower end of the tube forming the leg of the rollbar are connected together by a screw clamp that encompasses both the flange and the tube.

5. The roll cage according to claim 2, wherein the support plates weighs between 5 and 15 kg, in particular between 8 and 10 kg.

6. The roll cage according to claim 1, wherein each of the clamp elements is made of first and second oblong clamp parts which can be connected to one another by at least one threaded bolt, and that at least one of the first and second clamp parts has at least one trough or recess on its side facing the other of the first and second clamp parts wherein the at least one trough or recess is sized to encompass at least a portion of the Isofix attachment point.

7. The roll cage according to claim 6, wherein each of the first and second clamp parts is made of a metal strip or metal bracket that is 4 to 10 mm thick, in particular 5 to 8 mm thick.

8. The roll cage according to claim 6, wherein the first clamp part is welded to the rollbar, and the second claim part is screwed to the first clamp part.

9. The roll cage according to claim 6, wherein each of the first and second clamp parts has a trough on its side facing the other of the first and second clamp parts and when the first and second clamp parts are connected together the troughs of the first and second clamp parts form a cylindrical hole sized to encompass a mount on a respective one of the Isofix attachment points, the cylindrical hole having a diameter of at least 5 mm, in particular 5.5 mm to 6.5 mm which is transverse to the longitudinal axes of the first and second clamp parts.

10. The roll cage according to claim 6, wherein the first and second clamp parts are connected to one another by at least two threaded bolts, located successively behind one another in the longitudinal direction.

11. The roll cage according to claim 6, wherein the distance from the hole to the next threaded bolt is at least 3 cm.

12. The roll cage according to claim 1, wherein the rollbar and the two support elements or the two clamp elements or both are made of metal.

13. The roll cage according to claim 1, characterized in that the spacing between the two clamp elements can be adjusted.
